(19) United States
(12) Patent Application Publication
(10) Pub. No.: US 2020/0253106 A1
(43) Pub. Date: Aug. 13, 2020

(54) PRESS WHEEL AND TIRE FOR SUCH WHEEL

(71) Applicant: OTICO, Chalmaison (FR)

(72) Inventor: Olivier Phely, Chalmaison (FR)

(73) Assignee: OTICO, Chalmaison (FR)

(21) Appl. No.: 16/784,293

(22) Filed: Feb. 7, 2020

(30) Foreign Application Priority Data
Feb. 13, 2019 (FR) 19 01464

(51) Int. Cl. A01C 5/06

(52) U.S. Cl. CPC A01C 5/068; B60C 2013/007

(57) ABSTRACT

A press wheel comprises a rigid body and a semi-tubular tire. The tire comprises a flexible envelope with a sole portion through which the tire is mounted on the rigid body, a tread portion and a pair of sidewalls each one connecting the sole to the tread. The sidewalls extend, at least partially, along a generally concave profile, viewed from the exterior of the tire.

The invention relates to a press wheel, and more particularly to a press wheel of the type comprising a rigid body and a semi-tubular tire, this tire comprising a flexible envelope with a sole portion, through which the tire is mounted on the rigid body, a tread portion and a pair of sidewalls each one connecting the sole to the tread.

For work in fields, agricultural machines are provided with tools that are drawn, at a speed of about 15 to 20 kilometers per hour, along the field. In particular, seed drills comprise several tools that are different from each other and that work one after the other. Generally, these are first one or more head tools, typically coulters, disks or tines, arranged to open one or more furrows in the ground. Then come one or more intermediate tools, for the depositing of the seed, in particular grains, at the bottom of the furrows. Finally, at the end of the machine, one or more wheels are used to close the furrows or pack the earth.

Certain seed drills comprise at least one additional tool, called “firming wheel” or “press wheel” in the art, which works at the bottom of a furrow to press or bury the grains therein. A firming wheel thus operates between the head tool which is for the depositing of the grains and the tail wheels that close the furrow. A firming wheel, and more generally a press wheel, has a tire with a profile with a particular appearance, characterized by a high ratio of the height by the width, of about 2 to 3 for 1. This appearance allows in particular the firming wheel to roll at the bottom of a furrow without deteriorating the sidewalls of it.

In order to provide it with self-cleaning properties, the tire of a firming wheel is generally of the semi-tubular type. The adjectives “semi-rigid” and “non-inflatable” are also found in the art. In this type of tire, the flexible envelope surrounds a chamber that is in permanent fluidic communication with the exterior, in such a way that this envelope is deformed substantially when the tire is working.

Their semi-tubular construction and their high height to width ratio renders the tires of firming wheels particularly subject to buckling (bowing), in reaction to the force that these wheels apply at the bottom of the furrows. The tire is then deformed laterally, on one of the sides of the wheel, which can lead to a degradation of the furrow.

WO 2011/119095 discloses a tire of a firming wheel with an envelope of which the sidewalls extend generally along the radial direction of the tire and are domed outwards therefrom. The tread has a material thickness much greater than that of the sidewalls, of about 20 to 50 percent.

U.S. Pat. No. 3,181,622 also discloses a tire of a firming wheel, of the semi-tubular type, of which the annular envelope has a concave tread, in order to compact the bottom of the furrow, and sidewalls which each extend generally in a straight line and inclined with respect to the radial direction of the tire, approaching one another radially outwards. These sidewalls have a concave exterior surface, which is used to compact the sidewalls of the furrow. These sidewalls have a material thickness that is much greater than that of the tread so as to limit a deformation of the tire and retain the faculty of compacting the sidewalls of the furrow.

EP 3 207 784 A1 discloses a firming wheel devoid of a tire. The latter is replaced with a pair of rigid flanges, each one mounted on a wheel body and connected together, at their radially opposite edge to the body, by a ring, also rigid.

EP 1 461 988 A1 discloses a firming wheel of which the semi-tubular tire is conformed in such a way that its sidewalls are domed towards the exterior when a force is applied radially inwards. The envelope of the tire can be provided with a sole portion, or sheath, that connects the sidewalls together at their end radially opposite the tread, or with an open profile, i.e. the envelope is devoid of a sole. At rest, the sidewalls of the tire are domed outwards or extend parallel to one another, according to a generally straight profile.

As the known press wheels are satisfactory only very partially, the Applicant has sought to improve this situation.

A press wheel is proposed of the type comprising a rigid body and a semi-tubular tire. The tire comprises a flexible envelope with a sole portion through which the tire is mounted on the rigid body, a tread portion and a pair of sidewalls each one connecting the sole to the tread. The sidewalls extend, at least partially, along a generally concave profile, viewed from the exterior of the tire.

The proposed wheel retains the faculty of conventional wheels to work at the bottom of the furrow and that of their tires to be deformed for the purposes of self-cleaning. Contrary to conventional wheels, the deformation of the tire is controlled and directed in such a way that damaging the furrow is avoided, in particular the sidewalls thereof. The sidewalls are deformed towards the interior of the tire.

A kit is also proposed for forming a press wheel comprising a rigid body and a semi-tubular tire. The tire comprises a flexible envelope with a sole portion through which the tire is mounted on the rigid body, a tread portion and a pair of sidewalls each one connecting the sole to the tread. The sidewalls extend, at least partially, along a generally concave profile, viewed from the exterior of the tire.

Further proposed is a semi-tubular tire of a press wheel comprising a flexible envelope with a sole portion through which the tire is intended to be mounted on a rigid body, a tread portion and a pair of sidewalls each one connecting the sole to the tread. The sidewalls extend, at least partially, along a generally concave profile, viewed from the exterior of the tire.

Optional characteristics of the invention, additional or substitutive, are mentioned hereinafter.

The sidewalls extend generally according to a radial direction of the tire or along a direction inclined by less than 7 degrees with respect to this radial direction.

The sidewalls have a continuously curved profile, from the sole to the tread.

The sidewalls have a thickness that is generally constant from the sole to the tread.

The thickness of the sidewalls is less than the thickness of the tread.

The thickness of the sidewalls is less than the thickness of the sole.

The tire has a size along an axial direction that corresponds to the width of the tread.

The tire has a size along an axial direction that corresponds to the width of the sole.

The tire has a size along an axial direction that corresponds to the smallest width among the width of the tread and the width of the sole.

The sidewalls, or a concave portion thereof, are connected to at least one of the tread and the sole at a sharp edge.

The invention shall be better understood when reading the detailed description hereinafter, given in relation to the drawings, wherein:

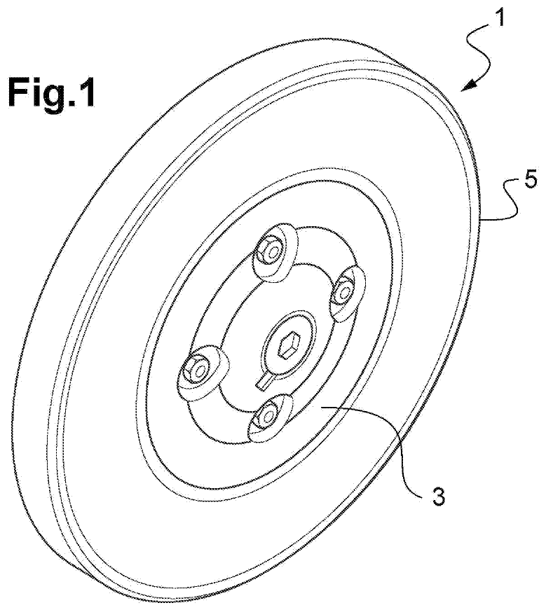

FIG. 1 shows a firming wheel according to the invention, in isometric perspective;

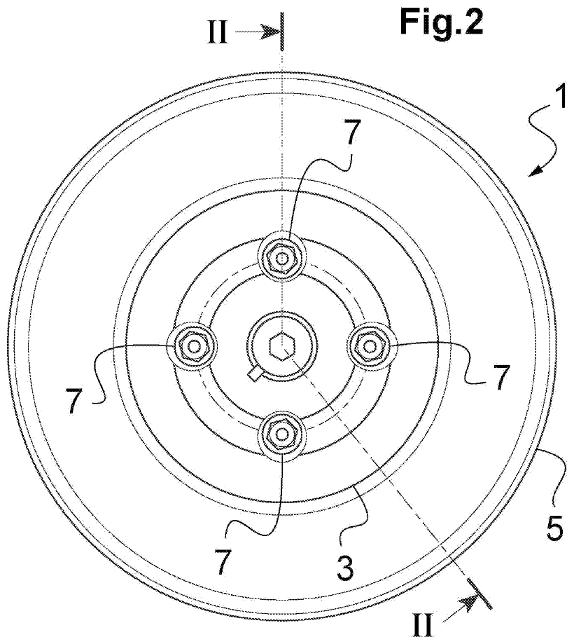

FIG. 2 shows the wheel of FIG. 1 in a front view;

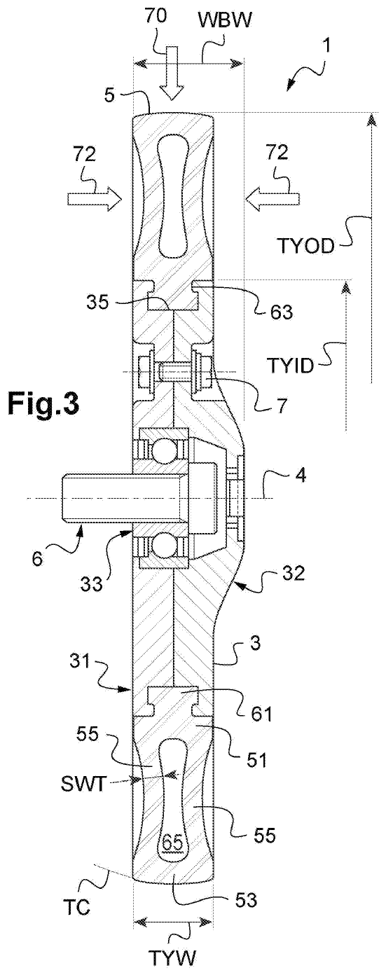

FIG. 3 shows the wheel of FIG. 2 in a cross-section according to a line II-II;

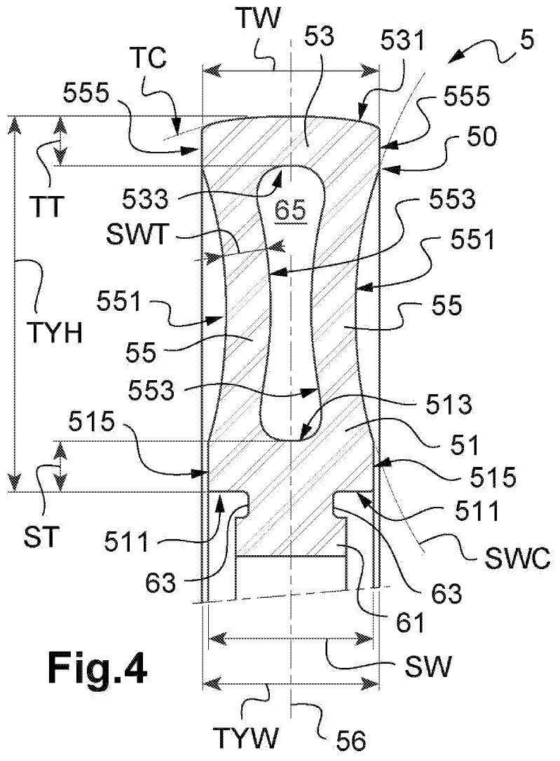

FIG. 4 shows a tire for the wheel of FIG. 1, in a radial cross-section view;

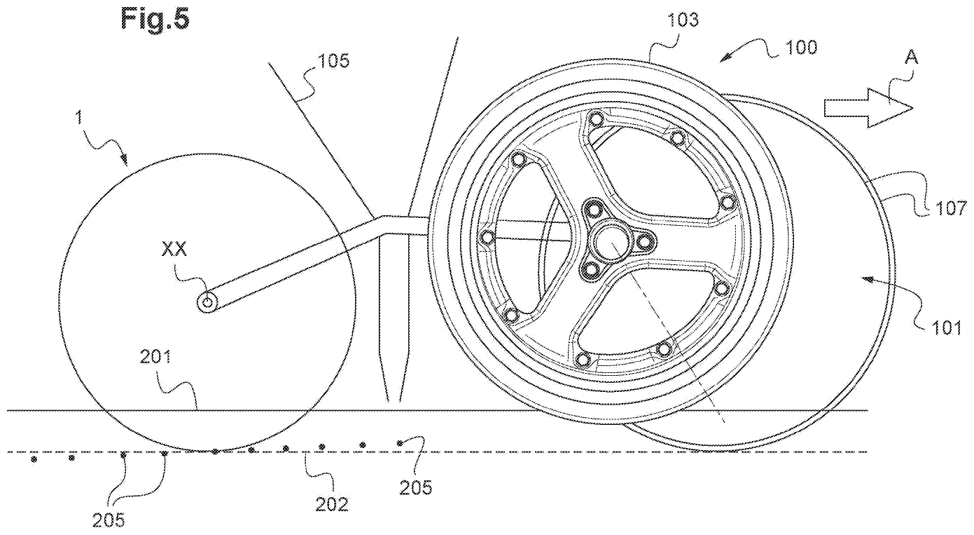

FIG. 5 diagrammatically shows a seed drill.

The drawings contain elements that are certain. They can therefore be used not only to describe the invention but also to contribute to the definition thereof, where applicable.

Reference is made to FIGS. 1 to 4.

They show an agricultural tool, able to work fields, in the form of a firming wheel 1. Such wheel 1 comprises a tire 5 and a wheel body 3, which forms a support around which the periphery 5 is mounted. The wheel 1 has a general appearance of revolution around an axis 4. To work, the wheel 1 is mounted in rotation around this axis 4, here on a portion of shaft 6.

Here, the body 3 comprises a first flange 31 and a second flange 32, each one with the general shape of a disk. Each one of the first flange 31 and the second flange 32 has a first large face and a second large face, not referenced, that extend each time in a manner that is generally parallel to one another. The first flange 31 and the second flange 32 are mounted on one another with a mutual bearing by one of their respective large faces, and thus maintained fastened, here thanks to a set of bolts 7.

In the assembled state of the wheel 1, the first flange 31 and the second flange 32 each house a respective longitudinal portion of a cylindrical bearing 33, here in the form of a bearing block. Each one of the first flange 31 and the second flange 32 has to do this a respective bore, substantially cylindrical, open on its large face facing the other of the first flange 31 and the second flange 32. The cylindrical bearing 33 interiorly receives the shaft 6.

The body 3 has a size in width, or width WBW 10, which corresponds here to the size in width of the wheel 1, or width WW. The central portion of the body 3 houses the bearing 33. This central portion corresponds to the widest portion of the body 3.

At the periphery of the wheel body 3 is a rim, which is partially formed by the peripheral edge of each one of the first flange 31 and the second flange 32. The rim has a peripheral groove 35, delimited here by portions of the first flange 31 and the second flange 32 close to their respective exterior edge. The groove 35 extends substantially over the circumference of the body 3 with an identical profile. The groove 35 is conformed in such a way as to receive a portion of the tire 5 in the form of a bead 61.

In the vicinity of their radially extreme edge, the first flange 31 and second flange 32 extend towards each other in such a way as to each form a profile in the shape of a hook. The hooks formed by the first flange 31 and the second flange 32 each cooperate with a respective groove of the bead 61 so as to hold the tire 5 on the body 3. The tire 5 is prevented from unintentionally coming off the rim, i.e. from separating from the body 3 when the wheel 1 is working. The tire 5 can be dismounted from the body 3 by detaching the first flange 31 from the second flange 32.

Alternatively, the tire 5 can be attached to the body 3 in a different manner. For example, the body 3 can have a generally cylindrical peripheral surface and the tire 5 be threaded by force into this surface. The body 3 can also be made of a single piece or by assembling more than two pieces together.

The body 3 forms a rigid portion of the wheel 1, in comparison with a deformable portion thereof, formed, for the most part, of the tire 5. The first flange 31 and the second flange 32 are rigid, for example, made from a metal or plastic material. The tire 5, or at least its envelope 50, is made from a flexible material of the rubber or elastomer type. For example, the envelope 50 is made from a rubber base with a Shore hardness A comprised between 35 and 70, for example environ 43 Shore. Furthermore, other elastomers can be used, for example polyurethanes.

The tire 5 comprises an envelope 50 interiorly delimiting a chamber 65. The envelope 50 is generally annular, with a radially internal portion, generally annular, forming a sole 51 (also called sheath) and a radially external portion, generally annular, formant a tread 53. The tread 53 is radially separated from the sole 51. The envelope 50 further comprises a pair of sidewalls 55 each one connecting a respective end of the sole 51 to a respective end of the tread 53. The sidewalls 55 each have a general appearance of a crown. The bead 61 protrudes from the sole 51, radially towards the center of the tire 5. Here, the tire 5 has a substantially identical profile over its circumference. When the tire 5 is not working, i.e. at rest or in the absence of exterior urging, as is the case in the figures, the sole 51 and the tread 53 extend substantially coaxially from one another, around the axis 4 of the tire 5.

The sole 51 has a substantially identical radial section on the circumference of the tire 5. The sole 51 has a radially exterior surface 511, here in two portions, on either side of the bead 61, and a radially interior surface 513, all with a cylindrical appearance. The exterior surface 511 of the sole 51 has a straight profile, parallel to the axis 4 of the tire 5, while the interior surface 513 thereof is slightly concave (viewed from the chamber 65). The tire 5 is mounted on the body 3 through the exterior surface 511 of the sole 51.

The exterior surface 511 and the bead 61 are delimited from one other by two substantially circular grooves 63, one on each large face of the tire 5.

The sole 51 further has two surfaces that form the axial ends 515 thereof. Each one of these ends 515 is shaped as a crown, with a straight profile along the radial direction of the tire 5.

The sole 51 has a width SW, which corresponds to its extent along the axial direction of the tire 5, and a thickness ST, which corresponds to its radial extent. The width SW corresponds to the mutual separation of the ends 515 of the sole 51 along the axial direction. The thickness ST corresponds to the radial distance that separates the interior surface 513 and the exterior surface 511 of the sole 51. Here, the sole 51 has a thickness ST that is practically constant from one axial end 515 to the other.

The tread 53 here has a profile, i.e. a radial section, that is substantially identical over the circumference of the tire 5. The tread 53 forms the radially exterior portion of this tire 5, or the portion of the tire 5 the farthest from the axis 4 of this tire 5.

The tread 53 has a generally annular shape, with an exterior surface 531 and an interior surface 533 mutually opposite according to the radial direction of the tire 5. The exterior surface 531 and the interior surface 533 of the tread 53 have a generally cylindrical appearance. The exterior surface 531 has a convex profile (see from the exterior of the tire 5). The exterior surface 531 of the tread 53 is slightly domed/arched, radially outwards, from one axial and from the tread 53 to the other. The radius of curvature of the tread 53 is noted as radius TC. The exterior surface 531 has a crown (not referenced) which is in the median plane of the tire 5. The tread 53 furthermore has two surfaces that form its axial ends 535. Each one of these ends 515 is shaped as a crown, with a straight profile along the radial direction. The interior surface 533 of the tread 53 extends here substantially parallel to the exterior surface 531 of this tread 53. Here, this interior surface 533 has a very slightly concave profile (see from the chamber 65), practically straight and parallel to the axial direction of the tire 5.

The tread 53 has a width TW, which corresponds to its extent according to the axial direction of the tire 5. The width TW corresponds to the separation between the axial ends 535 of the tread 53, according to the axial direction of the tire 5. The tread 53 has a thickness TT, which corresponds to its extent from the exterior surface 531 thereof according to a normal direction to this surface. The thickness TT corresponds to the separation between the interior surface 533 of the tread 53 and the exterior surface 531 of this tread 53. The tread 53 here has a thickness TT that is practically constant from one of its axial ends 535 to the other. Due to the rather low convexity of the exterior surface 531 of the tread 53, the thickness TT corresponds approximately to the extent of the tread 53 according to the radial direction of the tire 5.

The sidewalls 55 are arranged in mirror symmetry from one another according to a median plane 56 of the tire 5 perpendicular to the axis 4 of this tire 5. As a profile, the sidewalls 55 extend generally according to a radial direction. Each one of the sidewalls 55 has a concave profile viewed from the exterior of the tire 5 and convex viewed from the chamber 65. The sidewalls 55 are curved inwards of the tire 5, at least partially. Here, the sidewalls 55 are continuously curved inwards, from the tread 53 to the sole 51. Here, the sidewalls 55 have a curvature SWC, or concavity, that is substantially constant from the sole 51 to the tread 53. Each sidewall 55 has an exterior surface 551, that connects an end 515 of the sole 51 to an end 535 of the tread 53, and an interior surface 553, that connects the interior surface 513 of the sole 51 to the interior surface 533 of the tread 53. The exterior surface 551 and the interior surface 553 extend parallel to one another. The sidewalls 55 have a thickness SWT, corresponding to the separation between the exterior surface 551 and the interior surface 553. The thickness SWT is substantially constant, from the sole 51 to the tread 53. The bottom of each one of the sidewalls 55 is situated radially approximately at an equal distance from the exterior surface 511 of the sole 51 and from the exterior surface 531 of the tread 53.

The tire 5 has a height TYH, which corresponds to the distance which radially separates the exterior surface 531 of the tread 53, or the crown thereof, where applicable, from the exterior surface 511 of the sole 51. The tire 5 also has an outer diameter TYOD, measured at the exterior surface 531 of the tread 53, where applicable at the crown thereof, and an inner diameter TYID, measured at the interior surface 511 of the sole 51. In other words, the height TYH corresponds to half the difference of the diameter TYOD and the diameter TYID.

The size of the tire 5 in width, or width TYW, corresponds here to the largest width among the width SW of the sole 51 and the width TW of the tread 53. In the embodiment shown here, the width TW of the tread 53 is close to the width SW of the sole 51. In FIG. 4, the width SW of the sole 61 is slightly less than that TW of the tread 53, this solely so as to be able to distinguish these widths in this figure.

The interior surfaces 533 of the tread 53, 513 of the sole 51 and 553 of the sidewalls 55 are connected to each other through fillets. The exterior surface 531 of the tread 53 is connected to the end surfaces 555 thereof with a rounded edge. The exterior surface 551 of each one of the sidewalls 55 is connected respectively to an end surface 555 of the tread 53 and an end surface 515 of the sole 51 at sharp edges. This makes it possible to accentuate the deformable nature of the envelope. Especially, this favors the buckling of each one of the sidewalls 55, in a controlled manner, by keeping the tread 53 and the sole 51 practically undeformed.

The table hereinbelow gathers a set of dimensional values for the realization of a tire of a firming wheel in accordance with the figures, solely as an example.

TABLE 1

| | Value in | Range in |
|---|---|---|
| Dimension | millimeters | millimeters |
| Width WBW | 35.5 | |
| Width WW | 35.5 | |
| Width SW | 25 | up to about 30 |
| Thickness ST | 7 | 8 |
| Radius TC | 60 | 50 to 70 |
| Width TW | 25 | up to about 30 |
| Thickness TT | 7 | 8 |
| Thickness SWT | 6 | 5 to 7 |
| Hauteur TYH | 54 | up to 80 for TYW of 25 |
| Width TYW | 25 | 30 |
| Diameter TYID | 142 | |
| Diameter TYOD | 250 | up to 300 |

FIGS. 1 to 4 show the wheel 1 at rest, i.e. in a state where the tire 5 is not subjected to any exterior urging.

When the wheel 1 is working, the exterior surface 531 of the tread 53 of the tire 5 contacts the ground, here the bottom of a furrow so as to, for example, press the seed (grains in particular) therein. In reaction, the tire 5 is urged radially towards the center of the wheel 1. This urging is represented by the arrow 70 of FIG. 3.

The chamber 65 forms a space inside the tire 5, substantially annular and hollow. The chamber 65 is not inflated and non-inflatable. The chamber 65 is in fluidic communication with the exterior of the tire 5, which allows the envelope 50 to be deformed in reaction to the urging 70. This deformation of the envelope comprises the buckling, or sagging, of the sidewalls 55 jointly. The latter retain their generally radial extension. The concavity of the sidewalls 55 increases. The sidewalls 55 come closer to one another. This deformation is represented by the arrow 72 of FIG. 3. During work, the sole 51 remains immobile with respect to the body 3. The sole 51 is practically unable to be deformed in work, at least in comparison with the rest of the envelope of the tire 5.

The deformation of the envelope 50 contributes to the cleaning of the tire 5, in particular to the detaching of the earth which can adhere to the exterior surfaces thereof. Despite the deformation of this envelope 50, the tire 5 retains its axial size, which corresponds to the width of the tread 53 or that of the sole 51. Contact with the sidewalls of the furrow and damaging the latter is thus avoided. Also a controlled deformation of the tire 5 is retained as a whole, due to the concavity of the sidewalls 55, and this despite a substantial height TYH to width TYW ratio. This deformation is substantial, in particular compared to that of an envelope with sidewalls with a straight profile. The concavity of the sidewalls 55 forces the latter to deform towards the interior of the tire 5.

FIG. 5 diagrammatically shows a seed drill 100 and the organization of at least some of the tools that it is provided with. The arrow A represents the forward direction of the seed drill 100 relatively to the surface 201 of the ground. The seed drill 100 is provided with a head member 101 that can open a furrow in the ground, load-bearing wheels 103 that roll on the surface 201, a member 105 that can unitarily deposit grains 205 and a wheel 1 according to the invention.

Here, the head member 101 comprises a pair of disks 107 disposed one in relation to the other with a “V” profile. The disks 107 open a furrow in the ground 201, of which the dotted line 202 represents the bottom.

The load-bearing wheels 103 support at least partially the seed drill 101, on either side of the furrow. The load-bearing wheels 103 operate as gauge wheels, able to adjust the depth of the furrow. These load-bearing wheels 103 rotates freely and are integral with the disks 107 along a substantially vertical direction. Even in the presence of a drop, the disks 107 work at a depth that is substantially constant with respect to the surface 201.

The depositing member 105 is arranged to convey the grains 205 to the bottom 202 of the furrow, behind the head member 101. The wheel 1 drives the grains 205 into the bottom 202 of the furrow. Where applicable, one or more wheels can be provided at the tail of the seed drill 101 so as to close the furrow and/or pack the earth behind the wheel 1 (on the left of FIG. 5).

FIG. 5 shows the elements of the seed drill in a manner that is potentially further away than reality so as to better distinguish these elements. In practice, the depositing member can be between the disks 107 in such a way that the latter protect the deposit. Similarly, the firming wheel 1 can approach the depositing member 105 so as to act before the grain bounces.

The invention is not limited to the examples of agricultural tools described hereinabove, solely as examples, but it encompasses all the alternatives that those skilled in the art can consider within the framework of the claims hereinafter.

The press wheels are provided with tires with a high height to width ratio, generally comprised between 2 to 1 and 3 to 1, or between 1.5 to 1 and 3 to 1. A firming wheel has been described as an example of a press wheel. Firming wheels are distinguished from the other press wheels by the narrowness of the tire thereof: typically, the width TYW of a tire of a firming wheel is comprised between 15 and 30 millimeters, and generally greater than 20 millimeters. The outer diameter TYOD of a tire of this type is typically comprised between 170 and 300 millimeters. Other examples of press wheels include the wheels used to close up the furrows, which bear on the ground in the vicinity of the furrow. These wheels are generally provided with tires that are higher and wider than those of the firming wheels. Typically, the width TYW of these tires can reach 60 and even 70 millimeters, for an outer diameter TYOD comprised from 400 to 500 millimeters. In this case, the thickness ST can reach 12 millimeters. These wheels can be disposed straight, or in such a way as to form a “V” profile.

A firming wheel 1 is described of which the tire 5 has a height to width ratio that is somewhat greater than 2. In the case where the thickness or the thicknesses of the envelope 50 is reduced, for example to 4 or 3 millimeters on the average, it is possible to lower the minimum value of the height TYH to width TYW ratio, to 1 for 1. This, in particular for a firming wheel, but also, more generally, for any press wheel.

An envelope 50 has been shown of which the tread 53 and the sole 51 are substantially thicker than the sidewalls 55. This makes it possible to increase the deformation of the sidewalls 55 and to favor the latter, to the detriment of the tread 53 and/or of the sole 51. Furthermore, the tread 53 is advantageously thicker than the sidewalls 55 in order to overcome the wear thereof. Furthermore, the sole 51 is advantageously thicker than the sidewalls 55 in order to ensure the stability of the tire 5 on the body 3, including when the wheel 1 is working.

Sidewalls 55 have been shown that extend generally along the radial direction of the tire 55. A slight inclination of the direction of extension of the sidewalls in relation to the radial direction can be considered, for example of about 5 to 7 degrees at most. This inclination is such that the sidewalls 55 come closer to one another moving radially towards the exterior of the tire 5.

An advantageous situation is described where the tread 53 and the sole 51 have widths that are close to one another, in particular equal. A slight difference between these widths can be considered.

A tread 53 has been described with a slightly domed profile. Alternatively, the tread 53 can be conformed differently, according to for example the type of seed or characteristics of the ground to be worked. The tread 53 can for example have a straight profile. The tread 53 can thus have a more pronounced curvature, for example with a radius of about 12 millimeters, from one sidewall 55 to the other, or a localized curvature, which occupies only a portion of the tread 53, for example with a radius of 8 millimeters.

Sidewalls 55 that are continuously curved, from the sole 51 to the tread 53 have been described. Alternatively, it could be considered that, while still retaining their concave appearance when they are viewed from the exterior, only a portion of these sidewalls be curved, the rest of these sidewalls 55 then extending in a straight manner.

1. A press wheel of the type comprising:
a rigid body;
a semi-tubular tire, the tire comprising a flexible envelope with a sole portion through which the tire is mounted on the rigid body, a tread portion and a pair of sidewalls each one connecting the sole to the tread, wherein:
the sidewalls extend, at least partially, along a generally concave profile, viewed from the exterior of the tire.

2. The wheel according to claim 1, wherein the sidewalls extend generally along a radial direction of the tire or along a direction inclined by less than 7 degrees with respect to this radial direction.

3. The wheel according to claim 1, wherein the sidewalls have a continuously curved profile, from the sole to the tread.

4. The wheel according to claim 1, wherein the sidewalls have a generally constant thickness from the sole to the tread.

5. The wheel according to claim 4, wherein the thickness of the sidewalls is less than the thickness of the tread.

6. The wheel according to claim 4, wherein the thickness of the sidewalls is less than the thickness of the sole.

7. The wheel according to claim 1, wherein the tire has a size along an axial direction that corresponds to the width of the tread.

8. The wheel according to claim 1, wherein the tire has a size along an axial direction that corresponds to the width of the sole.

9. The wheel according to claim 1, wherein the tire has a size along an axial direction that corresponds to the largest width from among the width of the tread and the width of the sole.

10. The wheel according to claim 1, wherein the sidewalls, or a concave portion thereof, are connected to at least one of the tread and the sole at a sharp edge.

11. A kit for forming a press wheel comprising a rigid body and a semi-tubular tire, the tire comprising a flexible envelope with a sole portion through which the tire is mounted on the rigid body, a tread portion and a pair of sidewalls each one connecting the sole to the tread, wherein the sidewalls extend, at least partially, along a generally concave profile, viewed from the exterior of the tire.

12. A semi-tubular tire of a press wheel comprising a flexible envelope with a sole portion through which the tire is intended to be mounted on a rigid body, a tread portion and a pair of sidewalls each one connecting the sole to the tread, wherein the sidewalls extend, at least partially, along a generally concave profile, viewed from the exterior of the tire.
